(19) United States
(12) Patent Application Publication
(10) Pub. No.: US 2007/0041303 A1
(43) Pub. Date: Feb. 22, 2007

(54) Information storage medium and apparatus for reproducing the same

(75) Inventors: Ji-deog Kim, Seoul (KR); Chung-woo Lee, Seoul (KR); Chung-choo Chung, Seoul (KR); Bong-sik Kwak, Seoul (KR); Sang-han Lee, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/483,014

(22) Filed: Jul. 10, 2006

(30) Foreign Application Priority Data
Jul. 8, 2005 (KR) 10-2005-0061777

(51) Int. Cl. G11B 7/00

(52) U.S. Cl. 369/103

(57) ABSTRACT

An information storage medium stored hologram data images and an apparatus for reproducing data image from the same are provided. The medium includes a line-type servo image formed on one side of a hologram data image in radial direction. The apparatus includes an information storage medium, the first photodetector, and a signal processor. The first photodetector detects a servo image from the information storage medium and the signal processor generates at least one of a servo control signal and an address signal from a signal detected by the first photodetector.

### CROSS-REFERENCE TO RELATED PATENT APPLICATION

This application claims priority from Korean Patent Application No. 10-2005-0061777, filed on Jul. 8, 2005, in the Korean Intellectual Property Office, the disclosure of which is incorporated herein in its entirety by reference.

### BACKGROUND OF THE INVENTION

1. Field of the Invention

The present invention relates to an information storage medium and an apparatus for reproducing the same, and more particularly, to an information storage medium containing hologram image information thereon and an apparatus for reproducing the same.

2. Description of the Related Art

A holographic recording method for recording information on an optical information recording medium using a hologram image in high density, is known in the art. In the holographic recording method, signal beam containing image information is allowed to interfere with predetermined reference beam, so that a hologram interference pattern is generated on an information storage medium. That is, the hologram interference pattern is recorded on the optical information recording medium, so that image information therein may be recorded. To reproduce information from the recorded interference pattern, reproduction reference beam similar to the beam used when the hologram interference pattern is recorded should be illuminated onto the hologram interference pattern recorded on the optical information recording medium. The illumination of the reproduction reference beam generates diffraction due to the hologram interference pattern, by which image information is reproduced. In a volume holography, it is possible to achieve high-density information storage by recording holograms on the volume of an optical information recording medium in a superposition manner while changing physical properties of a reference beam.

FIG. 1 illustrates an example of the related art optical information recording medium where information is recorded using holography. FIG. 1 illustrates an optical information recording medium 1 disclosed in Japanese Patent Publication No. 2003-178484. Referring to FIG. 1, the related art recording medium 1 is a disk including a plurality of tracks. Each of the tracks includes a plurality of address and servo regions 6 provided with the same interval. Also, information recording regions 7 are located between the address and servo regions 6.

Information for generating a basic clock that serves as a reference for the timing of a variety of operations in an apparatus for recording and reproducing optical information, information used for performing a focus servo, information used for performing a tracking servo, and address information are recorded on the address and servo region 6.

However, in the related art recording medium 1, the address and servo regions 6, and the information storage regions 7 are separated from one another in a circumferential direction, so that a servo operation cannot be performed in sections where data is obtained from the information recording regions 7.

### SUMMARY OF THE INVENTION

The present invention provides an information storage medium and an apparatus for reproducing the same, capable of obtaining address information and performing a servo operation even in section where hologram image data is obtained.

According to an aspect of the present invention, there is provided an apparatus for reproducing a hologram data image from an information storage medium storing a hologram data image thereon, the apparatus including: a first photodetector detecting a servo image; and a signal processor generating at least one of a servo control signal and an address signal from a signal detected by the first photodetector, wherein the information storage medium includes a line-type servo image formed radially on one side of the hologram data image.

The line-type servo image may be used for obtaining a tracking error signal (TES), the first photodetector may include a first light receiving region and a second light receiving region arranged radially, and the signal processor may generate a TES from a differential between the signals detected from the first and second light receiving regions.

The signal processor may monitor whether a sum signal obtained by summing signals detected from the first and second light receiving regions exceeds a predetermined level and output a tracking control signal to allow a tracking control to be performed for a section where the sum signal exceeds the predetermined level.

The first photodetector may be one of a two-division photodetector where each of the first and second light receiving regions includes one light receiving region, and a four-division photodetector where each of the first and second light receiving regions includes two light receiving regions respectively arranged in the crossed direction to a track which is tangential to the radial direction.

The servo image may have a width smaller than the width of the first and second light receiving regions.

The servo image may have a length greater than or equal to the length that satisfies a stabilization time required for capturing the hologram data image.

The line-type servo image may include an address information image consisting of a plurality of non-continuous images representing address information, and the signal processor extracts address information from a signal detected by the first photodetector.

The signal processor may extract address information from a sum signal of the signals detected from a light receiving region of the first photodetector.

The information storage medium may further include a spot image formed at least on one side of the line-type servo image in radial direction.

The apparatus may further include at least one second photodetector divided into two portions in a direction perpendicular to the radial direction so as to output a detection signal used for generating a shuttering signal, the second photodetector detecting the spot image, wherein the signal processor subtracts a signal detected from a light receiving region on one side of the second photodetector from a signal detected from a light receiving region on the other side of the second photodetector in a radial direction, and the signal processor generates a shuttering signal used for determining a time point of capturing a hologram image from the differentiated signal.

The signal processor may monitor a time point at which the shuttering signal becomes a zero level and outputs a shuttering control signal to allow a hologram data image stored in the information storage medium to be captured at the time point where the shuttering signal becomes the zero level.

According to another aspect of the present invention, there is provided an information storage medium including: a hologram data image; and a line-type servo image formed on one side of the hologram data image in radial direction.

The line-type servo image may include an address information image consisting of a plurality of non-continuous images representing address information.

The information storage medium may further include a spot image formed at least on one side of the line-type servo image in radial direction.

### BRIEF DESCRIPTION OF THE DRAWINGS

The above and other aspects of the present invention will become more apparent by describing in detail exemplary embodiments thereof with reference to the attached drawings in which:

FIG. 1 is a view of a related art optical information recording medium;

FIG. 2 is a schematic block diagram of an exemplary embodiment of an apparatus for reproducing a hologram data image from an information storage medium according to the present invention;

FIG. 3 is a view of the information storage medium of FIG. 2;

FIG. 4 is an enlarged view illustrating a hologram data image, a servo image, and a spot image for shuttering formed on the information storage medium;

FIG. 5 is a detailed block diagram of the light detecting unit of FIG. 2;

FIG. 6 is a view illustrating a relative position of a servo image with respect to the first photodetector and illustrating a final waveform generated by passing a TES of FIG. 5 through a low-pass filter;

FIG. 7 is a view illustrating a servo image passing by the first photodetector and a waveform of a sum signal (A+B+C+D) detected therefrom;

FIG. 8 is a view illustrating a signal obtained by passing the sum signal of FIG. 7 through a high-pass filter;

FIG. 9 is a view illustrating a relative position of a spot image with respect to the second and third photodetectors and illustrating the waveform of a shuttering signal obtained in FIG. 5;

FIG. 10A is a view of an exemplary embodiment of a servo controller illustrated in FIG. 2;

FIG. 10B is a view illustrating a waveform for controlling a tracking according to the exemplary embodiment illustrated in FIG. 10A;

FIG. 11 is a view of an exemplary embodiment of a shuttering controller illustrated in FIG. 2;

FIG. 12 is a flowchart of a tracking control method according to an exemplary embodiment of the present invention; and

FIG. 13 is a flowchart of a shuttering control method according to an exemplary embodiment of the present invention.

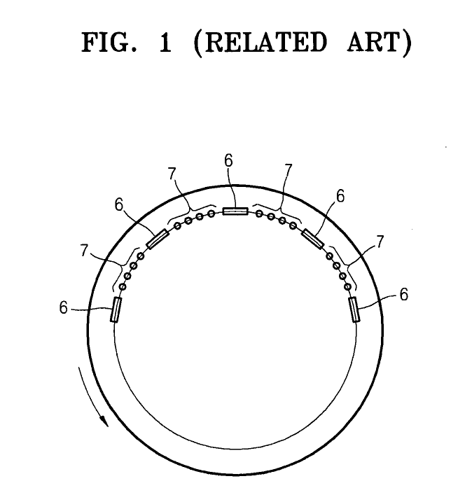

### DETAILED DESCRIPTION OF EXEMPLARY EMBODIMENTS OF THE INVENTION

The present invention will now be described more fully with reference to the accompanying drawings, in which exemplary embodiments of the invention are shown.

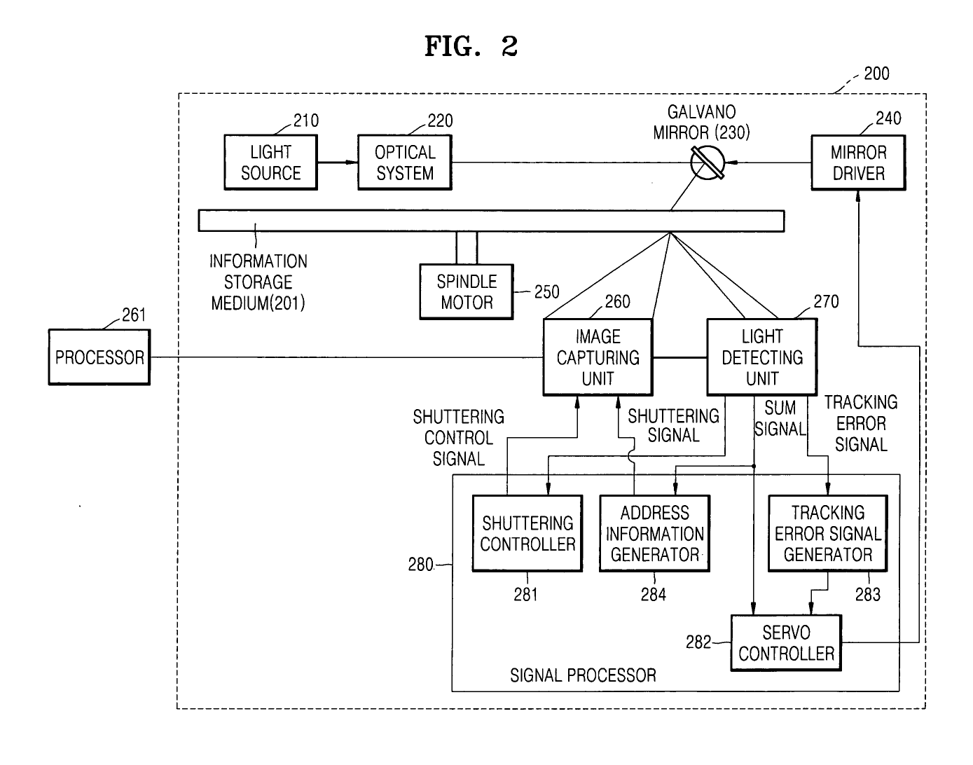

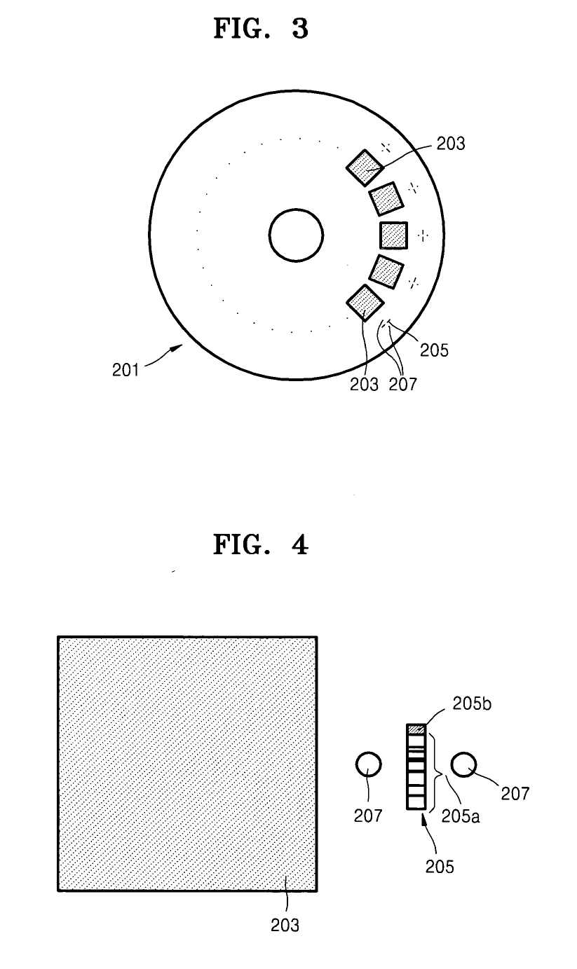

FIG. 2 is a schematic block diagram of an exemplary embodiment of an apparatus 200 for reproducing a hologram data image from an information storage medium according to the present invention, FIG. 3 is a view of the information storage medium 201 of FIG. 2, and FIG. 4 is an enlarged view illustrating a hologram data image 203, a servo image 205, and a spot image 207 for shuttering formed on the information storage medium 201.

Referring to FIG. 2, the reproducing apparatus 200 according to the exemplary embodiment includes the information storage medium 201, a light source 210, an optical system 220, a galvano-mirror 230, a mirror driver 240, a spindle motor 250, an image capturing unit 260, a light detecting unit 270, and a signal processor 280. The information storage medium 201 may be an optical information medium including a hologram layer.

The light from the light source 210, namely, a beam from a laser light source, is transmitted to the galvano-mirror 230 via the optical system 220 and reflected by the galvano-mirror 230 to be illuminated onto the information storage medium 201. The light illuminated onto the information storage medium 201 passes through the information storage medium 201 and is projected to the image capturing unit 260 and the light detecting unit 270.

The light detecting unit 270 detects a servo image and a spot image and generates a tracking error signal (or a signal used to generate a tracking error signal), a shuttering signal used for determining a time point at which a hologram data image 203 is captured, and a sum signal from the detected servo and spot images to provide the same to the signal processor 280.

The signal processor 280 outputs a tracking servo control signal and a shuttering control signal to the mirror driver 240 and the image capturing unit 260, respectively, in response to signals from the light detecting unit 270. Also, the signal processor 280 extracts address information from a sum signal and outputs the extracted address information to the image capturing unit 260 or the processor 261.

The signal processor 280 includes a shuttering controller 281, a tracking error signal generator 283, a servo controller 282, and an address information generator 284.

In response to a shuttering signal from the light detecting unit 270, the shuttering controller 281 detects a predetermined time point and provides a shuttering control signal to the image capturing unit 260 at the detected predetermined time point.

The tracking error signal generator 283 performs low-pass filtering on a signal received from the light detecting unit 270 to generate a final tracking error signal (TES). The tracking error signal generator 283 may include a low-pass filter (LPF).

The servo controller 282 receives a sum signal from the light detecting unit 270, receives a TES from the tracking error signal generator 283, detects a predetermined section of a sum signal, and performs a tracking control according to a tracking error signal using the detection results.

Here, the tracking error signal generator 283 may be included in the servo controller 282 or the light detecting unit 270. In the case where the tracking error signal generator 283 is included in the servo controller 282, the servo controller 282 receives a sum signal and a TES from the light detecting unit 270, detects a predetermined section of a sum signal, and performs a tracking control according to a tracking error signal using the detection results. In the case where the tracking error signal generator 283 is included in the light detecting unit 270, the servo controller 282 receives a sum signal and a TES from the light detecting unit 270.

The mirror driver 240 controls the position of the galvano-mirror 230 in response to a tracking control signal. The galvano-mirror 230 may include a voice coil motor (VCM).

When the shuttering control signal is received from the signal processor 280, the image capturing unit 260 captures a data image from the information storage medium 201 and outputs the captured data image to a processor 265 of a system (e.g., a computer or a player) including the apparatus for reproducing information according to the present invention.

Referring to FIGS. 3 and 4, an interference pattern (i.e., a hologram data image 203) due to interference between a signal beam having information and a reference beam is formed along a predetermined track within the information storage medium 201 using a holographic technology. Also, a line-type servo image 205 parallel to the hologram data image 203 is formed on a position in the information storage medium 201 radially spaced from a region where the hologram data image 203 is stored. Also, a spot image 207 for shuttering is radially formed in the information storage medium 201 to correspond to the hologram data image 203 at least on one side of the servo image 205. The hologram data image 203, the servo image 205, and the spot image 207 for shuttering are radially arranged within each track. Groups consisting of the hologram data image 203, the servo image 205, and the spot image 207 for shuttering are formed along tracks as illustrated in FIG. 3.

The servo image 205 is formed in a line shape on the whole and includes of an address information image 205a representing address information for a corresponding hologram data image and a preamble 205b informing the start point of the address information. Therefore, the servo image 205 may contain the address information therein. The address information image 205a consists of combinations of a plurality of various non-continuous images so as to express the address information. When address data is recorded on the servo image 205, the address data may be read while a servo, particularly, a tracking servo, is being performed. Here, the servo image 205 may be also formed in a simple line-type not containing the address information.

The servo image 205 may have a width smaller than the width of a predetermined light receiving region of the light detecting unit 270 for detecting the servo image 205 so that a push-pull TES may be detected. Also, the entire length of the servo image 205 may be greater than or equal to the length that satisfies a stabilization time within precision required for capturing the hologram data image 203. In that case, the capture operation for the hologram data image 203 may be performed under a perfect tracking control.

Referring to FIGS. 3 and 4, the spot image 207 for shuttering may be formed on both sides of the servo image 205 in radial direction. Also, the spot image 207 for shuttering may be formed on only one side of the servo image 205.

As described above, a signal image formed on each track of the information storage medium 201 consists of the hologram data image 203, the servo image 205, and the spot image 207 in a page unit. The signal image is radially arranged.

The apparatus for reproducing information detects the servo image 205 and the spot image 207 through the light detecting unit 270 to perform a tracking control, and detect a time point of capturing the hologram data image 203. Address information is extracted from a sum signal (e.g., RF-sum signal) of signals detecting the servo image 205. Also, the spot image 207 may be used for compensating the position of a reference beam.

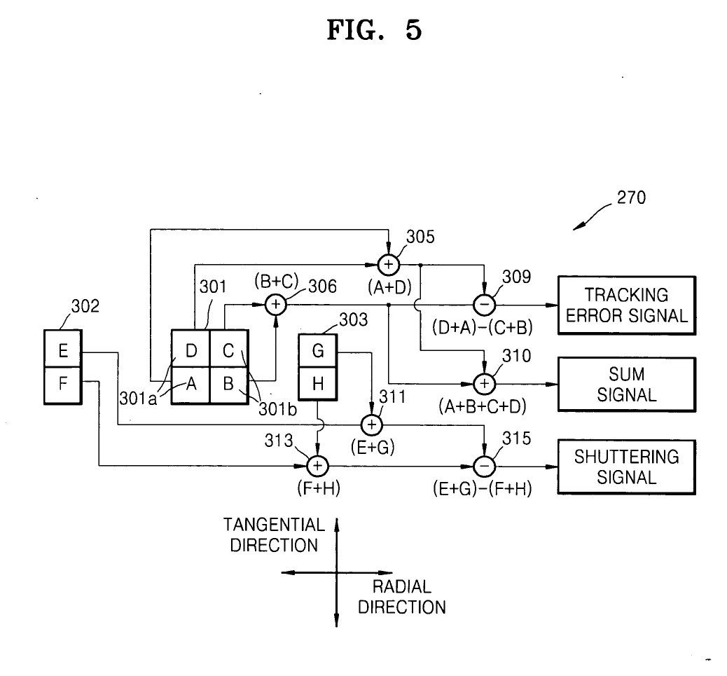

FIG. 5 is a detailed block diagram of a light detecting unit 207 of FIG. 2.

Referring to FIG. 5, the light detecting unit 270 includes the first photodetector 301 detecting the servo image 205, three adders 305, 306, and 310, and a subtracter 309 generating a TES and a sum signal from the signal detected by the first photodetector 301. Also, the light detecting unit 270 may further include the second and third photodetectors 302 and 303 detecting the spot image 207, two adders 311 and 313, and a subtracter 315 generating a shuttering signal from the signal detected by the second and third photodetectors 302 and 303.

The first photodetector 301 includes at least two light receiving regions radially formed so as to detect a TES. For example, the first photodetector 301 may include the first and second light receiving regions 301a and 301b radially arranged, and each of the first and second light receiving regions 301a and 301b consists of another two light receiving regions arranged in the crossed direction to a track which is tangential to the radial direction. That is, the first photodetector 301 may be a four-division photodetector having four light receiving regions A, B, C, and D.

Here, as mentioned above, the servo image 205 has a width smaller than the width of the respective light receiving regions A, B, C, and D of the first photodetector 301. Accordingly, a push-pull TES may be obtained by a relative position relation between the first photodetector 301 and the servo image 205 according to the radial direction.

Light corresponding to the portions of the servo image 205 and projected to the respective four light receiving regions A, B, C, and D is received in the four light receiving regions A, B, C, and D, where the receiving light is converted into electric signals. Signals detected from the four light receiving regions A, B, C, and D are represented by A, B, C, and D, respectively, for convenience.

The TES is a signal (A+D)−(B+C). In detail, the subtracter 309 receives a signal (A+D) from the adder 305 and a signal (B+C) from the adder 306, and subtracts the signal (B+C) from the signal (A+D). This TES may be used by applying low-pass filtering.

The sum signal is a signal (A+D)+(B+C). In detail, the adder 310 receives a signal (B+C) from the adder 306 and a signal (A+D) from the adder 305, and adds the signal (B+C) to the signal (A+D).

The second and third photodetectors 302 and 303 includes two light receiving regions E, F and G, H, respectively, arranged in the crossed direction to a track which is tangential to the radial direction so as to detect a shuttering signal.

The shuttering signal is a differential signal between a sum of signals detected from the light receiving regions E and G on one side of the second and third photodetectors 302 and 303, and a sum of signals detected from the light receiving regions F and H on the other side of the second and third photodetectors 302 and 303. That is, the shuttering signal is a signal (E+G)−(F+H). In detail, the subtracter 315 receives a signal (E+G) from the adder 311 and a signal (F+H) from the adder 313, and subtracts the signal (F+H) from the signal (E+G).

As described above, the light detecting unit 270 combines signals detected from the light receiving regions A, B, C, and D of the photodetector 301 receiving the servo image 205, to generate a TES ((A+D)−(B+C)) for a tracking servo and a sum signal (A+B+C+D). Also, the light detecting unit 270 combines signals detected from the light receiving regions E, F, and G, H of the second and third photodetectors 302 and 303 receiving a spot image 207, to generate a shuttering signal.

The TES, the shuttering signal, and the sum signal are input to the signal processor 280 as shown in FIG. 2. Here, a circuit detecting at least one of the TES, the shuttering signal, and the sum signal may be included in the signal processor 280, rather than in the light detecting unit 270.

When the TES passes through the tracking error signal generator 283, i.e., an LPF, a final tracking error signal is generated. When the sum signal passes through the address information generator 284, i.e., a high-pass filter (HPF), address data is obtained.

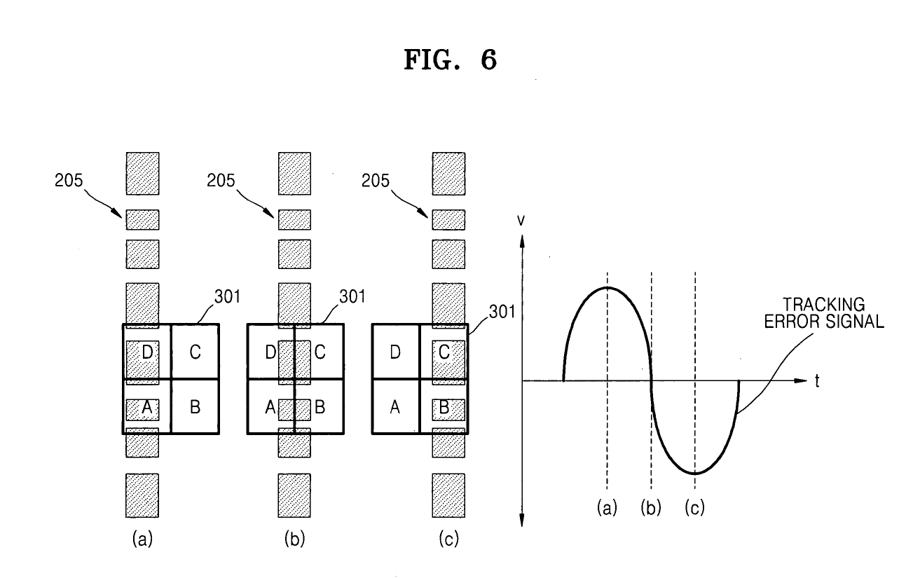

FIG. 6 is a view illustrating a relative position of a servo image 205 with respect to the first photodetector 301 and illustrating a final waveform generated by passing a TES of FIG. 5 through an LPF.

In FIG. 6, (a) illustrates the servo image 205 passes through the left side (i.e., the light receiving regions A and D) of the first photodetector 301, (b) illustrates the servo image 205 passes through the middle portion (i.e., the light receiving region A, B, C and D) of the first photodetector 301, and (c) illustrates the servo image 205 passes through the right side (i.e., the light receiving regions B and C) of the first photodetector 301. FIG. 6 also illustrates a signal waveform of the TES when the servo image 205 moves from a section (a) to a section (c). The TES has values of opposite signs when the servo image 205 passes through the section (a) and the section (c).

When the servo image 205 passes by the section (a), the value of the TES is the sum (maximum value) of the value of a signal detected in the light receiving region A and the value of a signal detected in the light receiving region D since signals are not detected in the light receiving regions B and C.

When the servo image 205 passes by the section (b) (i.e., the center of the first photodetector 301), the value of a TES obtained by subtracting the sum signal B+C from the sum signal A+D almost zero since the value of a sum signal (A+D) of signals detected in the light receiving regions A and D and the value of a sum signal (B+C) of signals detected in the light receiving regions B and C are almost the same.

When the servo image 205 passes by the section (c), the value of the TES is the sum (minimum value) of the value of a signal detected in the light receiving region B and the value of a signal detected in the light receiving region C since signals are not detected in the light receiving regions A and D.

A tracking control is performed in the section (b) where the value of the TES is zero. The degree the servo image 205 deviates from the center of the first photodetector 301 is represented by a deviation with respect to the section (b).

The length of a servo image 205 for a hologram data image 203 corresponding to information of one page may be greater than or equal to the length satisfying a stabilization time inside precision required for capturing the hologram data image 203. The stabilization time is a minimum time required for performing an operation of capturing a hologram data image 203 under perfect tracking control. The perfect tracking control means a tracking control is performed according to a TES obtained as the servo image 205 starts to be detected from the first photodetector 301 and within a predetermined deviation with respect to the section (b).

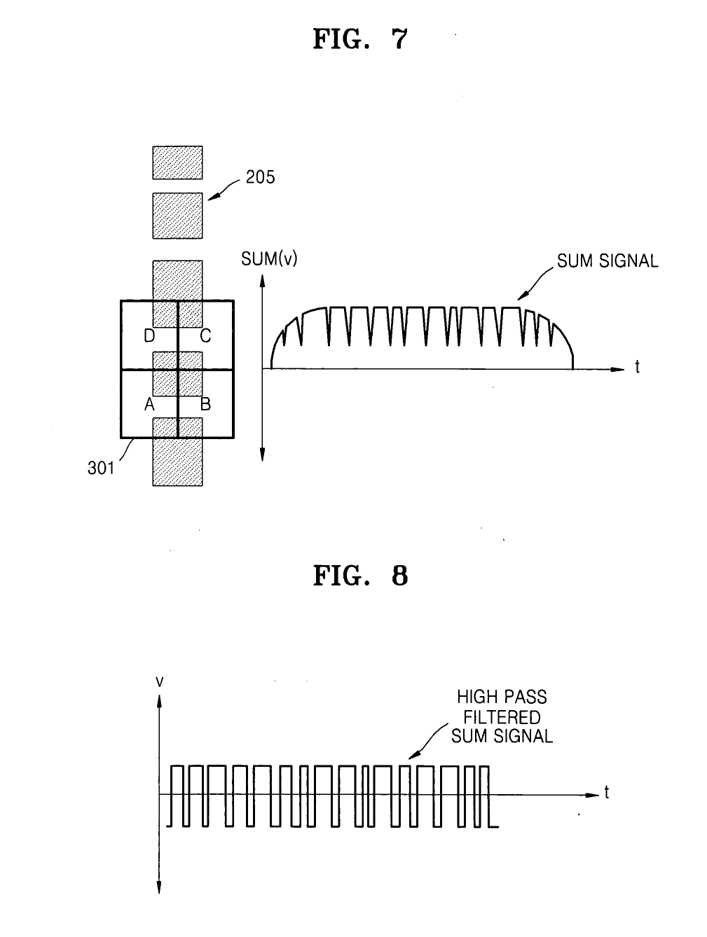

FIG. 7 is a view illustrating a servo image 205 passing through the first photodetector 301 and a waveform of a sum signal (A+B+C+D) detected therefrom.

The left-hand side of FIG. 7 illustrates the servo image 205 is positioned on the first photodetector 301 and the right-hand side of FIG. 7 also illustrates the waveform of a sum signal of FIG. 5 output as the servo image 205 passes through the first photodetector 301.

The reason the sum signal of the waveform is obtained as illustrated in FIG. 7 is that the line-type servo image 205 includes an address information image 205a and has a plurality of non-continuous images.

When the sum signal is input to the address information generator 284, i.e., an HPF so that high-pass filtering may be performed on the sum signal, a high-pass filtered sum signal is obtained as illustrated in FIG. 8. This high- pass filtered sum signal is address data in which the servo image 205 is stored. The length of the high-pass filtered signal changes according to the length of the respective non-continuous images, and a difference thereof is used for address data.

The sum signal may be used for a tracking control. At this point, when the sum signal is greater than or equal to a predetermined voltage level, a tracking control is started (control ON). When the sum signal falls down below a predetermined level, a tracking control is stopped (control OFF).

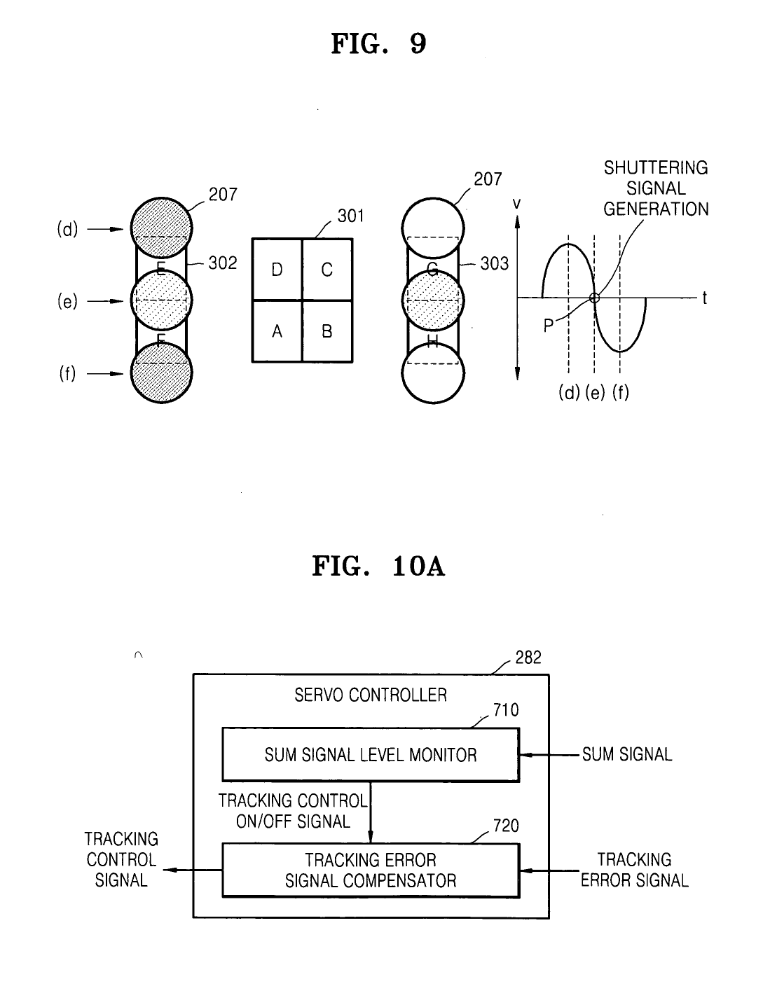

FIG. 9 is a view illustrating a relative position of a spot image 207 with respect to the second and third photodetectors 302 and 303 and illustrating the waveform of a shuttering signal of FIG. 5 obtained therefrom.

The left-hand side of FIG. 9 illustrates representative positions (d), (e), and (f) of the spot image 207 passing through the second and third detectors 302 and 303, and the right-hand side of FIG. 9 also illustrates the waveform of a shuttering signal output as the spot image 207 passes through the second and third photodetectors 302 and 303.

Referring to FIG. 9, when the spot image 207 passes through the section (d) that overlaps the half of the light receiving regions E and G of the second and third photodetectors 302 and 303, the value of a shuttering signal is the sum (maximum value) of the value of a signal detected in the light receiving region E of the second photodetector 302 and the value of a signal detected in the light receiving region G of the third photodetector 303 since a signal is not detected in the other light-receiving regions F and H of the second and third photodetectors 302 and 303.

When the spot image 207 passes through the section (e), which is the center of the second and third photodetectors 302 and 303, the values of signal detected in the two light receiving regions E and F of the second photodetector 302 are almost the same and the values of signal detected in the two light receiving regions G and H of the third photodetector 303 are almost the same, so that the value of a shuttering signal is almost zero.

When the spot image 207 passes through a section (f) that overlaps the half of other light receiving regions F and H of the second and third photodetectors 302 and 303, the value of a shuttering signal is a negative value (a minimum value) of a sum of the value of a signal detected in the other light receiving region F of the second photodetector 302 and the value of a signal detected in the other light receiving region H of the third photodetector 303 since a signal is not detected in the light receiving regions E and G of the second and third photodetectors 302 and 303.

With the spot image 207 positioned near the section (e), a shuttering signal for capturing a hologram data image 203 is generated at the neighborhood of a point P where the level of the shuttering signal becomes zero, so that the hologram data image 203 is captured.

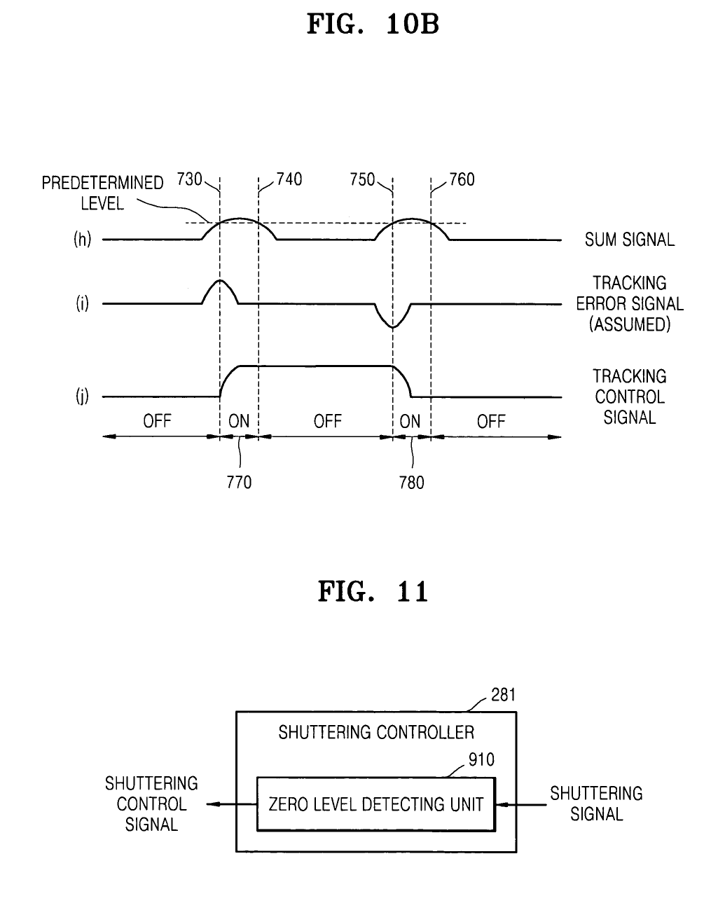

FIG. 10A is a view of an exemplary embodiment of a servo controller 282 illustrated in FIG. 2.

Referring to FIG. 10A, the servo controller 282 includes a sum signal level monitor 710 and a tracking error signal compensator 720.

The sum signal level monitor 710 receives a sum signal from the photodetector 270 to monitor whether the value of the received sum signal exceeds a predetermined level. When the level of the sum signal exceeds a predetermined level, the sum signal level monitor 710 provides a tracking control starting signal to the tracking error signal compensator 720.

The tracking error signal compensator 720 generates a tracking control signal for compensating a tracking error and outputs the same to the mirror driver 240 in response to a TES from the tracking error signal generator 283 and the tracking control starting signal from the sum signal level monitor 710.

FIG. 10B is a view illustrating a waveform for controlling a tracking according to the exemplary embodiment illustrated in FIG. 10A.

(h), (i), and () in FIG. 10B represents a sum signal, a tracking error signal, and a tracking control signal, respectively.

Referring to (h), the sum signal gradually has positive (+) values in a section where the servo image 205 passes through the first photodetector 301 and has zero value in a section where the servo image 205 does not pass through the first photodetector 301. Since the servo image 205 is not continuously recorded on the tracks of the information storage medium but is recorded on portions where the hologram data image 203 exists, side by side with the hologram data image 203, examination of (h) shows that the sum signal has a predetermined value in a section where the servo image 205 overlaps the first photodetector 301 and the sum signal has a zero value in the other sections.

The sum signal level monitor 710 performs a tracking control during a section where the servo image 205 passes by the first photodetector 301, particularly, sections 770 and 780 where the value of the sum signal exceeds a predetermined level. Referring to (h), when detecting the value of the sum signal exceeds a predetermined level at a time point 730, the sum signal level monitor 710 provides a tracking control-on signal to perform a tracking control. In detail, when a tracking error signal represents a positive (+) value as illustrated in (i), the sum signal level monitor 710 allows a tracking control signal to have a positive (+) value as illustrated in (j) to perform a tracking control. When detecting the value of the sum signal falls below a predetermined level at a time point 740, the sum signal level monitor 710 provides a tracking control-off signal to terminate a tracking control, so that a tracking control is not performed during a section between a point 740 and a point 750. That is, when the sum signal is lower than a predetermined level, a tracking control is off and the level of the control signal at this point is maintained constant to fix the position of the galvano-mirror 230.

A tracking control is performed likewise in a section 780 where a next arriving servo image passes by the first photodetector 301. For example, when a TES represents a negative (−) value as illustrated in (i), a tracking control signal is made negative (−) as illustrated in (j), so that a tracking control is performed.

FIG. 11 is a view of an exemplary embodiment of a shuttering controller 281 illustrated in FIG. 2.

Referring to FIG. 11, the shuttering controller 281 includes a zero level detecting unit 910.

The zero level detecting unit 910 receives a shuttering signal from the light detecting unit 270 to monitor whether the value of the received shuttering signal is a zero level. When the value of the received shuttering signal is a zero level, the zero level detecting unit 910 outputs a shuttering control signal to the image capturing unit 260.

Referring to FIG. 9, a shuttering signal has a shape similar to that of a sine wave changing from positive values to negative values in a section where the spot image 207 passes through the second and third photodetectors 302 and 303. The shuttering signal has a zero value in a section where the spot image 207 does not pass through the second and third photodetectors 302 and 303.

Since it is desirable that an image is obtained when the spot image 207 is located at an exact center of the second and third photodetectors 302 and 303, the zero level detecting unit 910 detects a point at which the value of a shuttering signal becomes zero in the section where the spot image 207 passes through the second and third photodetectors 302 and 303, that is, the section where the value of the shuttering signal changes from positive values to negative values, to output a shuttering control signal from the detected point.

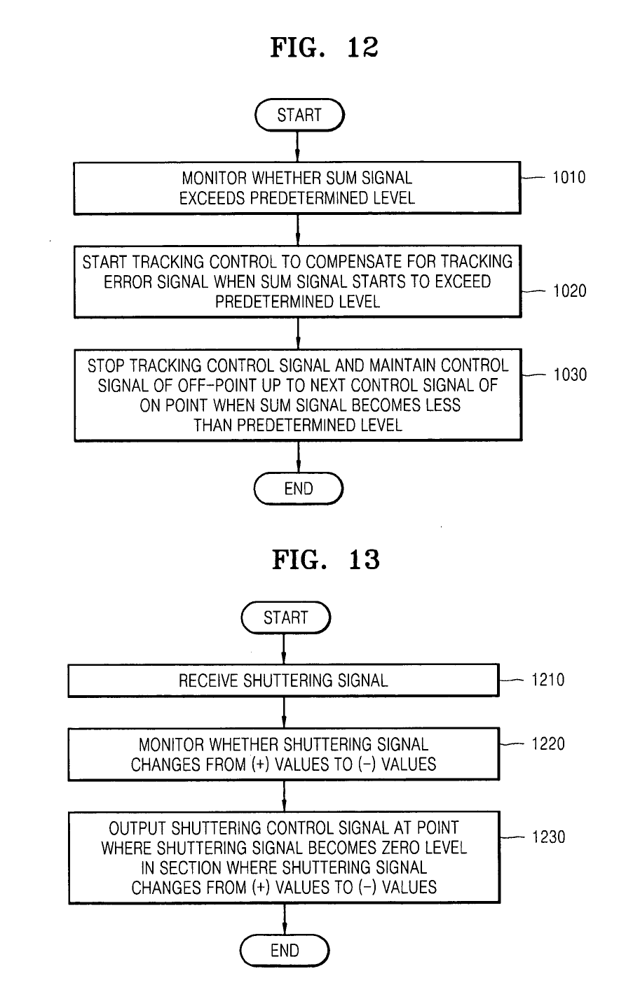

FIG. 12 is a flowchart of a tracking control method according to an exemplary embodiment of the present invention.

Referring to FIG. 12, when the light detecting unit 270 receives a signal projected from an information storage medium to output a sum signal, the sum signal level monitor 710 of the servo controller 282 monitors whether the value of the received sum signal exceeds a predetermined level (1010).

When the sum signal starts to exceed a predetermined level, the sum signal level monitor 710 transmits a signal to the tracking error signal compensator 720 to start a tracking control to compensate for a tracking error signal (1020).

When the sum signal becomes less than a predetermined level, the sum signal level monitor 710 transmits a signal to the tracking error signal compensator 720 to stop a tracking control (1030).

FIG. 13 is a flowchart of a shuttering control method according to an exemplary embodiment of the present invention.

Referring to FIG. 13, when the light detecting unit 270 receives a signal projected from an information storage medium to output a shuttering signal, the shuttering zero level detecting unit 910 of the shuttering controller 281 receives this shuttering signal (1210).

The zero level detecting unit 910 monitors whether the received shuttering signal becomes a zero point in the section where the value of a shuttering signal changes from positive values to negative values (1220).

The zero level detecting unit 910 outputs a shuttering control signal to the image capturing unit 260 at a point where the value of a shuttering signal becomes zero (1230).

In the above, the tracking control is performed by generating a TES from a signal detecting a line-type serve image 205.

In another exemplary embodiment, the servo image 205 may be used only for detecting address data and the tracking control may be allowed to use a signal detecting the spot image 207. In that case, the second and third photodetectors 302 and 303 may include four-division photodetector and the first photodetector 301 may consist of one light receiving region.

At this point, instead of using a sum of signals detected from the second and third photodetectors 302 and 303, a shuttering signal obtained from signal detected by the second and third photodetectors 302 and 303 may be used for performing a tracking control. That is, it is monitored whether the value of a shuttering signal belongs to a predetermined section. When the value of the shuttering signal belongs to a predetermined section, a tracking control start signal is provided to the tracking error signal compensator, so that a tracking control may be performed.

According to the inventive information storage medium and apparatus for reproducing the same, address information may be obtained and a servo may be applied even in the section where a hologram image data is being obtained.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for a reproducing hologram data image from an information storage medium storing a hologram data image thereon, the apparatus comprising:
a first photodetector which detects a servo image formed on the information storage medium; and
a signal processor which generates at least one of a servo control signal and an address signal from a signal output from the first photodetector,
wherein the line-type servo image is formed a radial direction on one side of the hologram data image.

2. The apparatus of claim 1, wherein the line-type servo image is used for obtaining a tracking error signal (TES), the first photodetector includes a first light receiving region and a second light receiving region arranged in the radial direction, and the signal processor generates a TES from a differential signal of signals detected from the first and second light receiving regions.

3. The apparatus of claim 2, wherein the signal processor monitors whether a sum signal obtained by summing signals detected from the first and second light receiving regions exceeds a predetermined level and outputs a tracking control signal to perform tracking control for a section where the sum signal exceeds the predetermined level.

4. The apparatus of claim 2, wherein the first photodetector comprises one of a two-division photodetector in which each of the first and second light receiving regions includes one light receiving region, and a four-division photodetector in which each of the first and second light receiving regions includes two light receiving regions respectively arranged in crossed direction to a track which is tangential to the radial direction.

5. The apparatus of claim 2, wherein the servo image has a width smaller which is than a width of the first and second light receiving regions.

6. The apparatus of claim 2, wherein the servo image has a length greater which is than or equal to a length that satisfies a stabilization time required for capturing the hologram data image.

7. The apparatus of claim 1, wherein the line-type servo image comprises an address information image including a plurality of non-continuous images representing address information, and the signal processor extracts address information from a signal output by the first photodetector.

8. The apparatus of claim 7, wherein the signal processor extracts address information from a sum signal of signals detected from a light receiving region of the first photodetector.

9. The apparatus of claim 8, wherein the information storage medium further includes a spot image formed at least on one side of the line-type servo image in the radial direction.

10. The apparatus of claim 9, further comprising at least one second photodetector which is divided into two portions arranged in a crossed direction to a track which is tangential to the radial direction so as to output a detection signal used for generating a shuttering signal, the second photodetector detecting the spot image,
wherein the signal processor subtracts a signal detected from a light receiving region on a first side of the second photodetector and a signal detected from a light receiving region on a second side of the second photodetector in the radial direction, and the signal processor generates a shuttering signal used for determining a time point of capturing a hologram image from the differential signal.

11. The apparatus of claim 10, wherein the signal processor monitors a time point at which the shuttering signal becomes a zero level and outputs a shuttering control signal to capture a hologram data image stored in the information storage medium at the time point at which the shuttering signal becomes the zero level.

12. The apparatus of claim 1, wherein the information storage medium further includes a spot image formed at least on one side of the line-type servo image in the radial direction.

13. The apparatus of claim 12, further comprising at least one second photodetector divided into two portions arranged in crossed direction to a track which is tangential to the radial direction so as to output a detection signal used for generating a shuttering signal, the second photodetector detecting the spot image,
wherein the signal processor subtracts a signal detected from a light receiving region on a first side of the second photodetector from a signal detected from a light receiving region on a second side of the second photodetector in a radial direction, and the signal processor generates a shuttering signal used for determining a time point of capturing a hologram image from the differential signal.

14. The apparatus of claim 13, wherein the signal processor monitors a time point at which the shuttering signal becomes a zero level and outputs a shuttering control signal to capture a hologram data image stored in the information storage medium at the time point at which the shuttering signal becomes the zero level.

15. An information storage medium comprising:
a hologram data image; and
a line-type servo image formed on one side of the hologram data image in a radial direction.

16. The information storage medium of claim 15, wherein the servo image is used for detecting a tracking error signal.

17. The information storage medium of claim 16, wherein the servo image has a width which is smaller than a width of one light receiving region of a photodetector detecting the servo image.

18. The information storage medium of claim 16, wherein the servo image has a length which is greater than or equal to a length that satisfies a stabilization time required for capturing the hologram data image.

19. The information storage medium of claim 15, wherein the line-type servo image comprises an address information image including a plurality of non-continuous images representing address information.

20. The information storage medium of claim 19, further comprising a spot image formed at least on one side of the line-type servo image in the radial direction.

21. The information storage medium of claim 20, wherein the spot image is used for generating a shuttering signal.

22. The information storage medium of claim 15, further comprising a spot image formed at least on one side of the line-type servo image in the radial direction.

23. The information storage medium of claim 22, wherein the spot image is used for generating a shuttering signal.
